(19) United States
(12) Patent Application Publication
(10) Pub. No.: US 2007/0072999 A1
(43) Pub. Date: Mar. 29, 2007

(54) Plasto-elastomeric compositions

(76) Inventor: Italo Carfagnini, Forli (IT)

Correspondence Address: GREENBERG TRAURIG LLP, 2450 COLORADO AVENUE, SUITE 400E, SANTA MONICA, CA, 90404, US

(21) Appl. No.: 10/574,638

(22) PCT Filed: Apr. 21, 2005
(86) PCT No.: PCT/IT05/00236

§ 371 Date: Mar. 31, 2006

(30) Foreign Application Priority Data
May 3, 2004 (IT) VR2004A000074

(51) Int. Cl. C08L 61/00; C08J 3/24

(52) U.S. Cl. 525/191; 525/132; 525/134

(57) ABSTRACT

An EPDM terpolymer and polyolefin based plasto-elastomeric composition containing the elastomeric phase partially or fully cross-linked, where for cross-linking it is possible to use, alternatively, an alkylphenol-formaldehyde non-halogenated resin or a phenol-formaldehyde non-halogenated resole resin, and where an aromatic carboxylic acid is used for cross-linking, in particular salicylic acid, fillers of mineral origin being added, either directly during the compounding step with cross-linking, or subsequently to the material that is already cross-linked, to achieve a total specific gravity of up to 2 kg/dm³ with hardnesses ranging from ShA 40 to ShD 50. The fillers of mineral origin being in a quantity which may reach almost 90% by weight of the composition.

### TECHNICAL FIELD

The present invention relates to plasto-elastomeric compositions basically consisting of EPDM terpolymers and polyolefins with fillers of mineral origin.

In particular, the present invention extends the properties of a material with the trade name Forprene®, which is a compound of thermoplastic elastomers comprising a mixture of vulcanised olefinic rubber and polyolefinic resin.

According to the present invention the basic composition of Forprene® is produced with a predetermined specific gravity, giving the end product characteristics which allow its use in different applications with a significant reduction in costs and the possibility of presenting a product with new characteristics that could not be achieved until now.

The composition according to this invention comprises elastomeric polymers, plastomeric polymers, fillers of mineral origin, various additives and oil in different percentages according to the uses and depending on the desired result.

The present invention can be applied in the industrial sector in the production of chemical products, in particular polymer alloy-based products.

### BACKGROUND ART

The preparation of thermoplastic compositions consisting of resins and EPDM terpolymer elastomers has been known and used for some time. To obtain compositions of this type according to patents FR 2.408.632 and U.S. Pat. No. 849,773 the cross-link agents used are a halogenated phenolic resin or a non-halogenated phenolic resin associated with halogen donors.

For improved processability, patent U.S. Pat. No. 4,477,631 suggests associating the non-halogenated phenolic resin with metal oxides or metal carbonates.

Elastomer vulcanisation techniques are also known which use the dynamic cross-linking system, for example as described in U.S. Pat. No. 3,884,882 in which the elastomeric copolymers are grafted beforehand with maleic anhydride to cross-link them and make them more compatible with plastomeric materials.

However, the use and study of known materials for the production of plasto-elastomeric compositions containing the elastomeric parts cross-linked by dynamic cross-linking by the cross-linking agents normally used in the rubber industry, has involved several problems.

Since in all of these known compositions, obtained using the traditional method of dynamic vulcanisation, disadvantages have been detected which greatly limit their use and the possibility of easy production, for example caused by non-homogeneous cross-linking of the rubber part or EPDM, and poor dispersion of the cross-linking agents in the entire plasto-elastomeric composition at temperatures equal to or greater than that at which the plastomer melts, with European patent EP-B-230212 the Applicant invented and protected a new process which would allow the production of plasto-elastomeric compositions with improved processability and better operating conditions for their industrial feasibility.

The process allowed limitation of the development of chlorine which is harmful to the environment and allowed operation at significantly lower temperatures and shorter processing times.

This result was achieved by using a non-halogenated phenolic resin with a special aromatic carboxylic acid, for dynamic cross-linking of the EPDM elastomer contained in the plasto-elastomeric mixture.

According to said European patent, the non-halogenated phenolic resin used for cross-linking is an alkylphenol-formaldehyde resin, considering that, in addition to the non-halogenated phenolic resin, it was essential to use an aromatic carboxylic acid for cross-linking, in particular salicylic acid.

It is a process for preparing plasto-elastomeric compositions based on EPDM and polyolefins containing the partially or fully cross-linked elastomeric phase, whose characteristic is given by the fact that a non-halogenated phenolic resin and an aromatic carboxylic acid are used for cross-linking.

The non-halogenated phenolic resin used for cross-linking is a alkylphenol-formaldehyde resin with the following general formula: 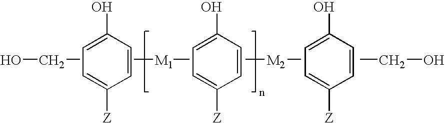
where: M₁ and M₂ are —CH₂— or —CH₂—C—CH₂— radicals, which may be the same or different, Z is an alkylene, acrylic or alkyl radical containing between 4 and 16 carbon atoms, and n is an integer between 0 and 6.

In an alternative embodiment, the phenolic resin that can be used in the process according to said European patent is a resole resin of the phenol-formaldehyde type with the formula:

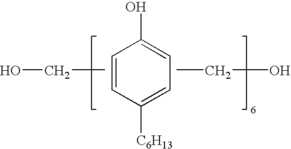

According to said European patent, in addition to the non-halogenated phenolic resin, it is essential to use an aromatic carboxylic acid for cross-linking, and salicylic acid has proved particularly suitable, this acid having the following characteristics:

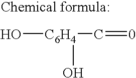

Molecular weight=138.12

Melting point=159° C.

Specific gravity=1.37 g/cm³

The vulcanisation system used therefore consists of a combination of an alkylphenol-formaldehyde type resin, preferably phenol-formaldehyde resole resin, with salicylic acid, where for each part of resin, measured by weight, between 0.1 and 0.8 parts salicylic acid is used, again measured by weight.

The process for preparing plasto-elastomeric compositions therefore consists in particular of subjecting to mastication with apparatuses designed for the plastics and/or rubbers sector, such as Banbury type internal mixers, compounding screws, roller mixers, Buss type mixers, etc., mixtures with 10-80% of their weight formed by EPDM terpolymer (consisting of at least two α-olefinic monomers and at least one dienic monomer) in the presence of a cross-linking system with 0.5-15 parts by weight for every 100 parts of EPDM, of a non-halogenated phenolic resin and of salicylic acid in a weight ratio with said resin of between 0.1/1 and 0.8/1.

Preparation takes place at a temperature equal to or higher than (preferably higher than) the “melting” point of the olefinic thermoplastic used and for a time sufficient to obtain a homogeneous mixture and partial or full (preferably full) cross-linking of the EPDM rubber part contained in the mixture.

This operation may be performed in a single compounding machine such as those indicated above, or in several machines positioned in a logical sequence (for example: Banbury+extruder, or turbo mixer “dry” mixer and twin screw extruder, Banbury+Buss, etc.).

Whatever the choice of machines, operations must always be dynamic and comply with the time, temperature and revolutions per minute of the machines so as to obtain the following sequence:

a) mastication of the EPDM elastomer and polyolefinic plastomer “melting”;

b) homogeneous dispersion of the components;

c) cross-linking of the elastomeric part;

d) homogeneous dispersion of any additives.

This system allows a fine dispersion of the cross-linked EPDM elastomer to be obtained (non-discrete phase) within the “melted” plastomeric component (discrete phase) and with the cross-linked elastomer in the form of tiny spheroidal particles with a diameter of between 0.1 and 1.5 microns.

Operations are preferably performed at temperatures of between 160 and 240° C. and the duration of mastication depends on the following factors:

a) the degree of cross-linking to be imparted to the EPDM elastomer contained in the composition;

b) the quantity, as a % of the weight, of diene present in the EPDM elastomer polymeric chain;

c) the weight quantity of the two above-mentioned cross-linking agents (phenolic resin+salicylic acid).

As regards the basic components of the compositions, the following must also be added:
1) the degree of EPDM cross-linking: this is between 10 and 100% by weight of the total quantity present in the composition. The weight is preferably between 50 and 98%.
2) The amount of diene present in the EPDM elastomer: the parameter is defined by the degree of non-saturation and is normally expressed by the quantity, by weight, of diene for every 100 parts, by weight, of elastomer; this value varies between 1 and 15% by weight, the EPDM elastomers preferably containing between 3 and 8% by weight of diene for the total EPDM elastomer.
3) The quantities of phenolic resin to be used for dynamic cross-linking of the EPDM elastomer are between 0.5 and 15 parts by weight per 100 parts of EPDM by weight, whilst between 0.05 and 12 pats by weight of salicylic acid is used per 100 parts of EPDM by weight.

In dynamically cross-linked plasto-elastomeric mixtures there may also be the usual additives for this type of composition, such as organic strengthening ingredients (e.g.: carbon black) and inorganic ingredients (e.g.: silica, silicates), plasticisers (e.g.: mineral oils, waxes, paraffins), fillers (inert fillers such as carbonates, kaolins, talc, calcined clay, barytes, asbestos, etc.), antioxidants, antiozonants, anti U.V., peptizing and anti-packing agents, organic and inorganic pigments, vulcanisation promoters.

All of the components which contribute to the formation of the plasto-elastomeric compositions are substances that are known or can be prepared using known processes, taking into account the following.

The term EPDM terpolymers refers to mainly amorphous polymers consisting of ethylene and of at least one α-olefin (propylene, butene-1) and of a type of diene conjugated or not conjugated in the main polymeric chain and consisting of: ethylidene-norbornene; 1,4-hexadiene; dicyclopentadiene; 2-methyl-1,4-pentadiene; 1,4,9-decatriene; 1,5-cyclooctadiene; 1-methyl-1,5-cyclooctadiene; 1,4-cyclopentadiene; polybutene, polybutadiene and the substitution derivatives of such monomers.

They have a molecular weight of between 50,000 and 800,000: an ethylene content of between 20 and 80% in moles, a bound diene content of between 1 and 15% by weight per 100 parts of polymer by weight and the remainder consists of a propylene or butylene α-olefin.

The term olefinic plastomers is used herein to refer to the products of copolymerisation of olefinic monomers such as:

ethylene; propylene; 1-butene; 1-pentene; 1-hexene, 4-methyl-1-pentene; 3-methyl-1-1pentene, 3,3-dimethyl-1-butene; 3-methyl-1-hexene; 2,4,4-trimethyl-1-pentene.

The copolymerisation of homogeneous or non-homogeneous monomers (e.g.: “RANDOM” type copolymers) occurs in the presence of metallo-organic compounds (catalysts, e.g.: AlEt₃; AlEt₃Cl; Al (is Bu₃) with soluble vanadium compounds (e.g.: VCl₄; VOCl₃; VAC₃) where (Et=ethylene; AC=acetylacetone; is Bu=isobutyl).

The term phenolic resins, defined by the general formula indicated above, refers to those resins which may be prepared by the condensation of alkyl-phenols with formic aldehyde for example as described in literature (Kunststoffe Vol. 52, 1962, pages 19 to 21).

As already indicated, the compositions according to European patent EP-B-230212 are marketed with the name Forprene®.

### DISCLOSURE OF THE INVENTION

The invention aims to provide a polymeric formulation for plasto-elastomeric compositions based on dynamically cross-linked EPDM terpolymers and polyolefins, which is easy to produce so that it is economically advantageous.

Moreover, the invention aims to provide a plasto-elastomeric composition based on EPDM terpolymers and polyolefins which can be used in different applications, for example:

sound-deadening panels;

extruded profiles;

satinised surfaces;

low shrinkage materials;

applications requiring a specific gravity well above that of water;

halogen-free flame-proof compositions;

compositions for filling synthetic football fields.

This is achieved using a plasto-elastomeric composition based on EPDM terpolymers and polyolefins whose characteristics are described in the main claim.

The dependent claims of the polymeric formation disclosed refer to advantageous embodiments of the invention.

The end product made using such a composition also has the advantage of being recyclable, and costing less than other materials such as polyurethane.

The product may be defined recyclable, environmentally friendly and non-toxic, since it does not release toxic substances into the environment, and it is also free of heavy metals in compliance with current legislation, it does, not produce dusts and is resistant to ageing.

Other features and advantages of the invention are apparent in the following description of a preferred embodiment of the invention, by way of example and without limiting the scope of the inventive concept.

### DESCRIPTION OF A PREFERRED EMBODIMENT OF TH INVENTION

Production of the formulation according to this invention involves the initial preparation of a predetermined quantity of a composition based on a mixture of vulcanised olefinic resin and polyolefinic resin. In particular such a composition is known with the brand name Forprene®.

Fillers of mineral origin are added to said basic composition to reach a total specific gravity of around 2 kg/dm³, for a quantity which reaches up to a value close to 90% by weight, and with hardnesses ranging from ShA 40 to ShD 50.

The fillers of mineral origin may consists of the following components:

Calcium carbonate (coated and uncoated);

aluminium hydroxide;

magnesium hydroxide;

Barytes.

The calcium carbonate—chemical formula CaCO₃—may or may not be pure, precipitated or not, and its specific gravity is 2.71 g/cm³.

The aluminium hydroxide—chemical formula Al(OH)₃—has a typical specific gravity of 2.42 g/cm³ and usually begins decomposing at 180° C., finishing at 320° C.

The magnesium hydroxide—chemical formula Mg(OH)₂—typically begins decomposing at 300° C. and finishes at 450° C.

Finally, the Barytes—chemical formula BaSO₄—is a more or less pure barium sulphate with different colours depending on where it is extracted and a typical specific gravity of 4.48 g/cm³, which is a high value for a non-metallic mineral.

The addition of these fillers of mineral origin to the Forprene® allows the creation of a composition suitable for various applications, to prepare manufactured products which may be identified, without in any way limiting them, by the following: sound-deadening panels, extruded profiles, satinised surfaces, low shrinkage materials, applications requiring a specific gravity well below that of water.

Moreover, adding magnesium and/or aluminium hydroxide in quantities of up to 75%, with other additives produces a composition with marked flame-proof characteristics, to the point that with regard to the UL 94 classification, the composition can exceed VO product coding.

This type of composition may be used for filling synthetic football fields or for sports fields and equipment in general.

The capacity of the composition according to this invention to incorporate a high percentage of fillers of mineral origin, up to 90%, means that it can be used as a product suitable for filling football fields made of synthetic grass.

It behaves similarly to vulcanised crumb rubber but without having the latter's disadvantages in terms of pollution of the ground below, packing, smell, and above all no recycling.

This is basically due to the intrinsic characteristics of the starting material (Forprene®), which is a dynamically cross-linked EPDM mixed with a homo or copo polypropylene and polyethylene LDPE/LLDPE/HDPE, making it perfectly recyclable.

For this reason the basic composition of Forprene® is preferably vulcanised SBR, EPDM or EPM vulcanised either with peroxide or with other systems, above all in the car and electrical appliances industry.

Finally, it should be noticed that, surprisingly, even if the above-mentioned fillers of mineral origin are added, the Forprene® based composition according to this invention still maintains optimum elastic and thermoplastic characteristics, making the composition suitable for moulding, extrusion, reworking and regenerating several times.

The composition according to this invention may be produced in any colour, depending on the specific requirements for its use.

The following are some examples of production of the composition according to this invention. These examples illustrate the invention without limiting it in any way.

TABLE 1
corresponds to a halogen-free flame-proof composition:

| Formula No. 1 - HALOGEN FREE FLAME-PROOF | | kg | % | |
|---|---|---|---|---|
| Forprene | | 35 | 35 | |
| Magnesium Hydroxide | | 65 | 65 | |
| | | | | VALUES |
| INITIAL PROPERTIES | | METHOD | UNIT | MEASURED |
| DUREZZA | dopo 3 sec | ASTM D 2240 | Shore A | 80 |
| HARDNESS | after 3 sec | | | |
| DUREZZA | dopo 15 sec | ASTM D 2240 | Shore A | 78 |
| HARDNESS | after 15 sec | | | |
| CARICO a ROTTURA | | ASTM D 412 - C | MPa | 2.4 |
| TENSILE STRENGTH | | | | |
| ALLUNGAMENTO a ROTTURA | | ASTM D 412 - C | % | 160 |
| ELONGATION at BREAK | | | | |
| MODULO 100% | | ASTM D 412 - C | MPa | 1.5 |
| MODULUS 100% | | | | |
| LACERAZIONE | | ASTM D 624 - C | N/mm | 15 |
| TEAR STRENGTH | | | | |
| PESO SPECIFICO | | ASTM D 792 | g/cm_{—} | 1.6 |
| SPECIFIC GRAVITY | | | | |
| MELT FLOW INDEX | 200° C. 5 kg | ASTM D 1238 | g/10′ | 0.5 |
| TENSION SET | 10 min. 23° C. | ASTM D 412 | % | 50 |

TABLE 2
corresponds to a sound-deadening composition:

| Formula No. 2 - SOUND-DEADENING | | kg | % | |
|---|---|---|---|---|
| Forprene | | 40 | 40 | |
| Barytes | | 60 | 60 | |
| | | | | VALUES |
| INITIAL PROPERTIES | | METHOD | UNIT | MEASURED |
| DUREZZA | dopo 3 sec | ASTM D 2240 | Shore A | 74 |
| HARDNESS | after 3 sec | | | |
| DUREZZA | dopo 15 sec | ASTM D 2240 | Shore A | 71 |
| HARDNESS | after 15 sec | | | |
| CARICO a ROTTURA | | ASTM D 412 - C | Mpa | 2.0 |
| TENSILE STRENGTH | | | | |
| ALLUNGAMENTO a ROTTURA | | ASTM D 412 - C | % | 310 |
| ELONGATION at BREAK | | | | |
| MODULO 100% | | ASTM D 412 - C | Mpa | 1.4 |
| MODULUS 100% | | | | |
| MODULO 300% | | ASTM D 412 - C | Mpa | 1.4 |
| MODULUS 300% | | | | |
| LACERAZIONE | | ASTM D 624 - C | N/mm | 15 |
| TEAR STRENGTH | | | | |
| PESO SPECIFICO | | ASTM D 792 | g/cm_{—} | 1.7 |
| SPECIFIC GRAVITY | | | | |
| MELT FLOW INDEX | 200° C. 5 kg | ASTM D 1238 | g/10′ | 8 |
| TENSION SET | 10 min. 23° C. | ASTM D 412 | % | 60 |

TABLE 3
corresponds to a composition for filling synthetic football fields:

| Formula No. 3 - FOOTBALL FIELDS | | kg | % | |
|---|---|---|---|---|
| Forprene | | 40 | 40 | |
| Calcium Carbonate | | 60 | 60 | |
| | | | | VALUES |
| INITIAL PROPERTIES | | METHOD | UNIT | MEASURED |
| DUREZZA | dopo 3 sec | ASTM D 2240 | Shore A | 40-60 |
| HARDNESS | after 3 sec | | | |
| DUREZZA | dopo 15 sec | ASTM D 2240 | Shore A | 37-57 |
| HARDNESS | after 15 sec | | | |
| CARICO a ROTTURA | | ASTM D 412 - C | MPa | 1.2-2.2 |
| TENSILE STRENGTH | | | | |
| ALLUNGAMENTO a ROTTURA | | ASTM D 412 - C | % | 200-400 |
| ELONGATION at BREAK | | | | |
| MODULO 100% | | ASTM D 412 - C | MPa | 1-2 |
| MODULUS 100% | | | | |
| MODULO 300% | | ASTM D 412 - C | MPa | / |
| MODULUS 300% | | | | |
| PESO SPECIFICO | | ASTM D 792 | g/cm_{—} | 1.2-1.8 |
| SPECIFIC GRAVITY | | | | |
| MELT FLOW INDEX | 200° C. 5 kg | ASTM D 1238 | g/10′ | 0.5-2 |

The invention is described above with reference to a preferred embodiment. However, obviously the invention may be subject to variations without thereby departing from the scope of the inventive concept, with technically equivalent elements.

1. An EPDM terpolymer and polyolefin based plasto-elastomeric composition containing the partially or fully cross-linked elastomeric phase, where for cross-linking it is possible to use, alternatively:
a) a formula (I) alkylphenol-formaldehyde non-halogenated phenolic resin, where M₁ and M₂ are —CH₂— or CH₂—C—CH₂— radicals, which may be the same or different, Z is an alkylene, acrylic or alkyl radical containing between 4 and 16 carbon atoms, and n is an integer between 0 and 6: 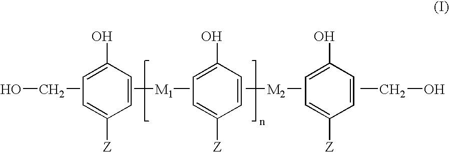
b) a formula (II) phenol-formaldehyde non-halogenated resole resin with the formula: 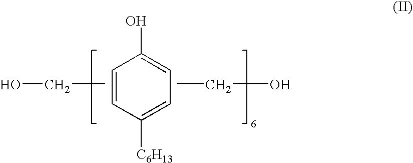
and in which, in addition to the non-halogenated phenolic resin, an aromatic carboxylic acid is used for cross-linking, in particular salicylic acid, where for each part by weight of resin between 0.1 and 0.8 parts by weight of salicylic acid are used, in which the composition fillers of mineral origin are added to it, directly in the compounding step with cross-linking or subsequently to the material that is already cross-linked, to achieve a total specific gravity of up to 2 kg/dm³ and having hardnesses ranging from ShA 40 to ShD 50, the fillers of mineral origin being in a quantity which may be as much as almost 90% by weight of the composition.

2. The plasto-elastomeric composition of claim 1, wherein polyolefin is the product of the copolymerisation of olefinic monomers selected from ethylene, propylene, 1-butene, 1-pentene, 1-hexene, 4-methyl-1-pentene, 3-methyl-1-pentene, 3,3-dimethyl-1-butene, 3-methyl-1-hexene, 2,4,4 trimethyl-1-pentene.

3. The composition of claim 1, wherein the part to which fillers of mineral origin are not added contains between 10 and 90% of polyolefin and between 90 and 10% of a EPDM terpolymer.

4. The composition of claim 3, wherein the EPDM terpolymer consists of at least two olefinic monomers and one dienic monomer conjugated or not conjugated in the main polymeric chain.

5. The composition of claim 4, wherein the olefinic monomers are selected from ethylene, propylene, butene-1.

6. The composition of claim 4, wherein the dienic monomer is selected from ethylidene-norbornene, 1,4-hexadiene, dicyclopentadiene, 2-methyl-1,4-pentadiene, 1,4,9-decatriene, 1,5-cyclopentadiene, polybutene, polybutadiene and their derivatives.

7. The plasto-elastomeric composition of claim 1, wherein the fillers of mineral origin are calcium carbonate CaCO₃ which may or may not be coated, pure or impure, precipitated or not.

8. The plasto-elastomeric composition of claim 7, wherein the calcium carbonate has a typical specific gravity of 2.71 g/cm³.

9. The plasto-elastomeric composition of claim 1, wherein the fillers of mineral origin are aluminium hydroxide—chemical formula Al(OH)₃.

10. The plasto-elastomeric composition of claim 9, wherein the aluminium hydroxide has a typical specific gravity of 2.42 g/cm³.

11. The plasto-elastomeric composition of claim 1, wherein the fillers of mineral origin are magnesium hydroxide—chemical formula Mg(OH)₂.

12. The plasto-elastomeric composition of claim 1, wherein the fillers of mineral origin are Barytes—chemical formula BaSO₄.

13. The plasto-elastomeric composition of claim 12, wherein the Barytes is a barium sulphate with different colours and has a typical specific gravity of 4.48 g/cm³.

14. The plasto-elastomeric composition of claim 9, wherein the magnesium and/or aluminium hydroxide are present in quantities of up to 75%, giving the product flame-proof characteristics.
